(19) United States
(12) Patent Application Publication
(10) Pub. No.: US 2016/0101425 A1
(43) Pub. Date: Apr. 14, 2016

(54) DEVICE FOR COMMINUTING ABRASIVE MATERIALS

(71) Applicant: THYSSENKRUPP INDUSTRIAL SOLUTIONS AG, Essen (DE)

(72) Inventor: Michael DREPPER, Münster (DE)

(73) Assignee: THYSSENKRUPP INDUSTRIAL SOLUTIONS AG, Essen (DE)

(21) Appl. No.: 14/786,444

(22) PCT Filed: Apr. 22, 2014
(86) PCT No.: PCT/EP2014/058102

§ 371 Date: Oct. 22, 2015

(30) Foreign Application Priority Data
Apr. 23, 2013 (DE) 10 2013 104 098.5

(51) Int. Cl. B02C 4/30; B02C 1/10

(52) U.S. Cl. CPC B02C 4/305; B02C 1/10

(57) ABSTRACT

The inventive apparatus for comminuting abrasive materials having at least one component is provided with a wear-protection profile which is formed by a multiplicity of welds made of an iron-chromium-carbon hard alloy having a hardness of greater than 55 HRC, wherein the welds have a geometric length-to-width ratio of ≦4, preferably ≦2.5, more preferably ≦1.5.

The invention relates to an apparatus for comminuting abrasive materials having at least one component which is provided with a welded wear-protection profile.

Examples of these apparatuses are roller presses or vertical cylinder mills such as are used in particular in the cement and mineral industry. Those components which come into contact with the material to be comminuted, such as grinding rollers or grinding plates, are exposed, during operation, to various wear mechanisms such as abhesion, abrasion or tribo-chemical reactions or to a combination of these wear mechanisms. If the wear protection is formed by deposition welding, various welding methods are used to apply single- or multilayer wear-protection coatings. The welds conventionally consist of a highly wear-resistant iron-chromium-carbon hard alloy with additions of niobium, titanium, boron, molybdenum, vanadium, tungsten and manganese and having hardnesses of greater than 55 HRC. These alloys have a martensitic and/or also austenitic matrix with embedded hard phases. The hard phases are chromium carbides and special carbides which form primarily or eutectically. The carbide content and the size of the carbides are markedly greater than is possible in the cast state. In comparison to the wear-resistant, carbidic, cementite-solidified cast iron materials, the pure welding materials of these hard alloys have greater wear resistance.

In the case of comminuting rollers, as are used for example in material bed roller mills in the cement industry, use is also made, inter alia, of forged materials or wear-resistant cast-iron materials. In the case of the forged materials, a whole-surface deposition welding is indispensable for protecting the material during operation. A profile is additionally welded on for process engineering reasons. By contrast, a whole-surface deposition welding is not necessary in the case of comminuting rollers made of wear-resistant cast-iron materials, such that only a welded-on profile is applied. For these profiles, use is commonly made of highly wear-resistant iron-chromium-carbon hard alloys.

In EP 0 916 407 B1, a wear-resistant cast-iron material for comminuting rollers is provided with deposition welds. And in EP 0 563 564 A2, the wear protection layer is formed by applying weld beads made of a wear-resistant deposition welding material to the surface of a white cast iron roller jacket. However, when using an iron-chromium-carbon hard alloy, cracks in the welding material have been identified already upon cooling of the hard deposition welding material.

The invention is based on the object of indicating a wear-protection profile made of an iron-chromium-carbon hard alloy which is essentially crack-free.

According to the invention, this object is achieved with the features of claim 1.

The inventive apparatus for comminuting abrasive materials having at least one component is provided with a wear-protection profile which is formed by a multiplicity of welds made of an iron-chromium-carbon hard alloy having a hardness of greater than 55 HRC, wherein the welds have a geometric length-to-width ratio of ≦4, preferably ≦2.5, more preferably ≦1.5.

Usually, the welding material experiences, upon solidification, a reduction in volume, wherein the longitudinal shrinkage in the welding direction is counteracted by the self-supporting effect within the welding material, thus giving rise to tensile stresses within the welding material. If the yield point is exceeded, these tensile stresses are released by means of a conventional deformation of the welding material in the welding direction. If, in the process, the tensile stresses exceed the tensile strength of the welding material, this results in crack formation perpendicular to the welding direction. If the geometric length-to-width ratio is ≦4, the welding material is able to shrink freely without counteracting the shrinkage and the build-up of stresses within the welding material is reduced to the point that crack formation does not occur.

Further refinements of the invention form the subject matter of the subclaims.

The welds are preferably applied with a separation with respect to one another, possibly also in particular resulting in a repeating pattern. The welds can preferably have a height of up to 15 mm, preferably up to 10 mm and most preferably in the range from 3 to 7 mm. The welds can take the form of weld seams or preferably spot welds. In the case of spot welds, it has proven advantageous for the diameter to be in the range from 7 to 25 mm, preferably in the range from 10 to 20 mm and for the height to be in the range from 7 to 20 mm.

The filler material used for the welds can form, in addition to carbides of iron and of chromium, also special carbides (such as of niobium, vanadium, titanium). Furthermore, the wear-protection profile is preferably applied to a body formed of
a. a bainitic nodular cast iron having an elongation at break of approximately 0.1 to 2.5%, a compressive strength of 1000 to approximately 1800 MPa and a hardness of 42 to 55 HRC or
b. a carbidic cementite-solidified cast iron material having carbides of iron, chromium, molybdenum, vanadium and/or niobium or
c. a forged material.

The component onto which the welded wear-protection profile is applied is preferably a cylinder, a roller, a cone, a ball or a crusher jaw for a mill or a crusher. It can also be a grinding track or plate segments of a mill.

Further advantages and refinements of the invention will be explained below with reference to the following description and the drawing, in which:

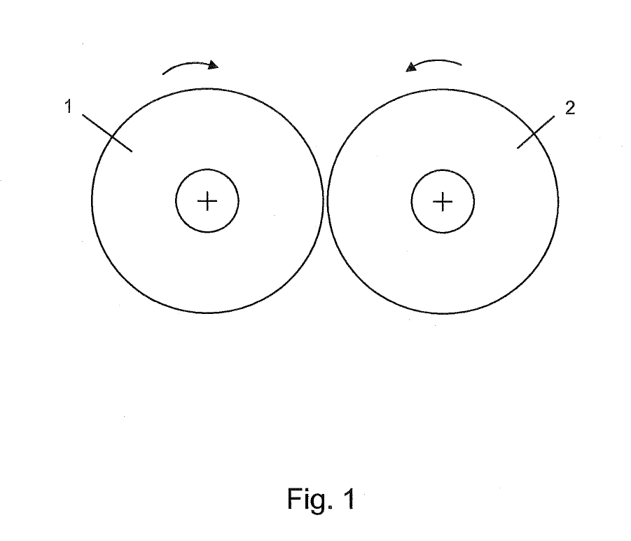

FIG. 1 a schematic representation of a roller press,

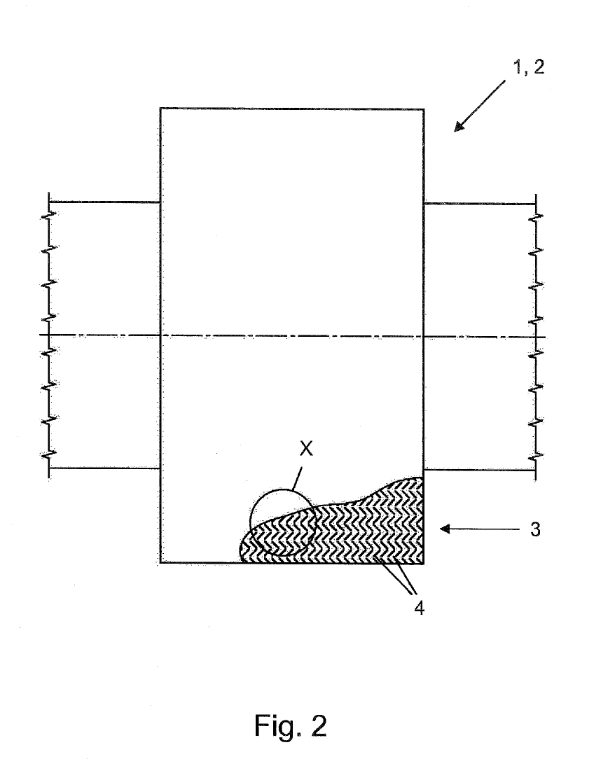

FIG. 2 a schematic representation of a grinding roller,

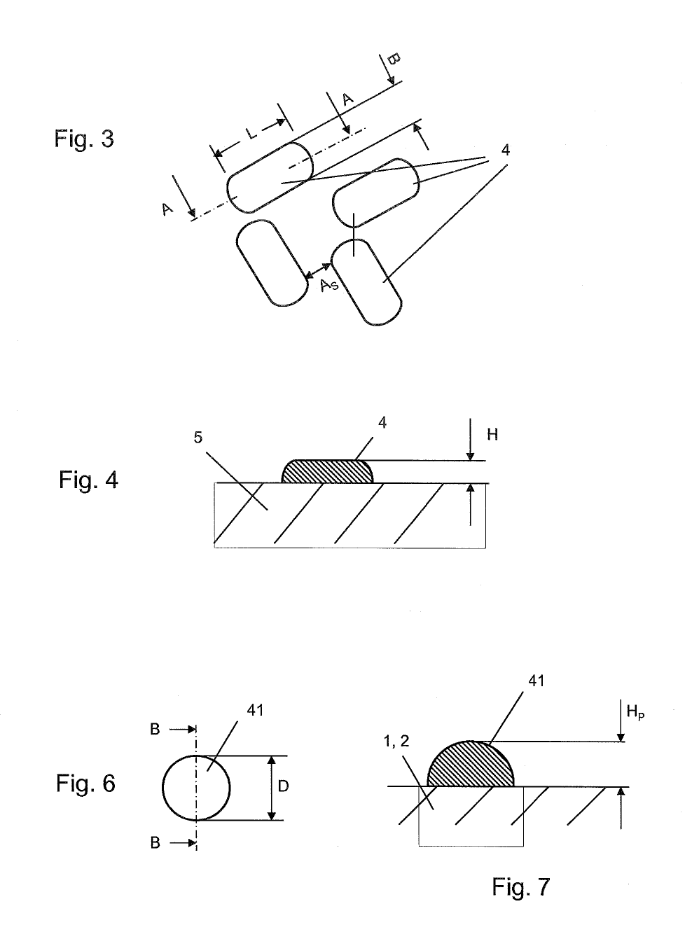

FIG. 3 an enlarged, schematic representation of the wear-protection profile from the detail X of FIG. 2,

FIG. 4 a sectional representation along the line A-A of FIG. 2,

FIG. 5 various patterns of the wear-protection profile,

FIG. 6 a schematic plan view of a wear-protection profile in the form of a spot weld,

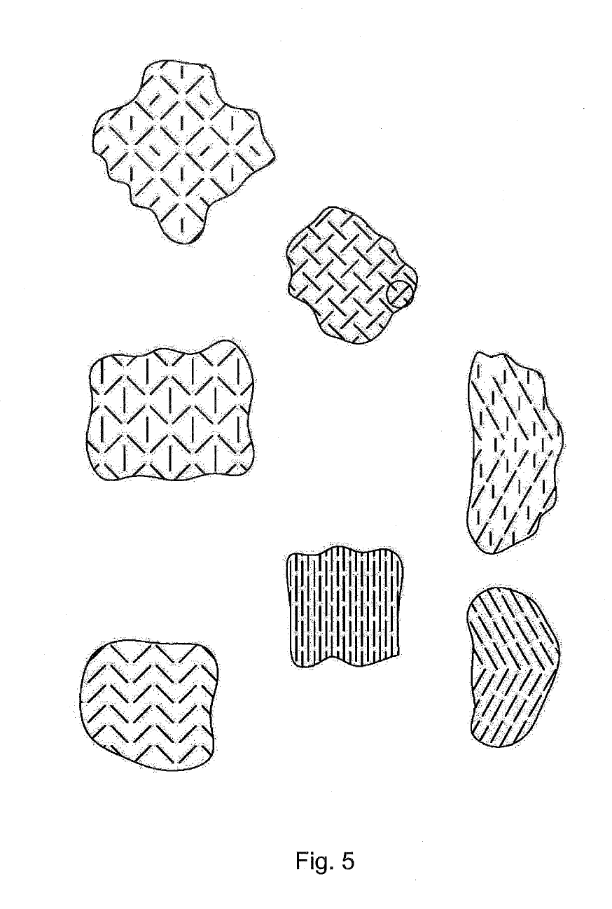

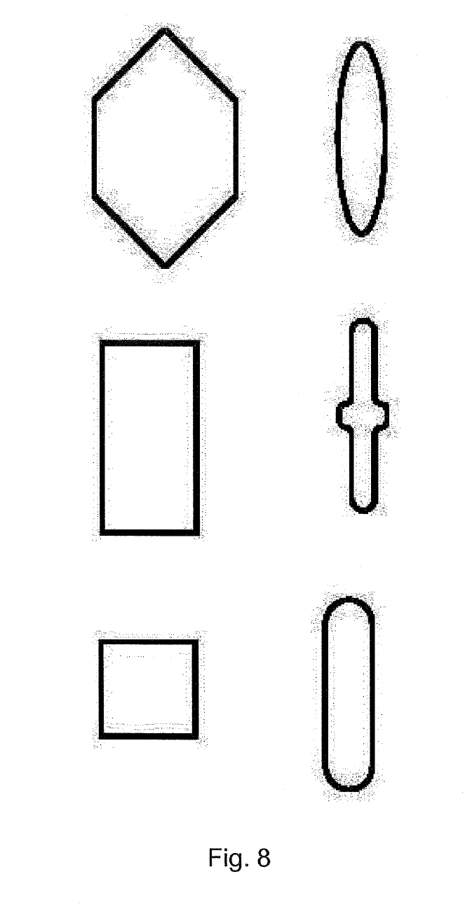

FIG. 7 a sectional representation along the line B-B of FIG. 6, and

FIG. 8 various forms of the welds for the wear-protection profile.

The apparatus, represented in FIGS. 1 and 2, for comminuting abrasive materials is a roller press with two grinding rollers 1, 2 that are pressed against each other and are driven in counter-rotation, and can for example take the form of a material bed roller mill as is used in the cement and minerals industry. The rollers then commonly have a diameter of 1 to 2 m.

The circumferential surface of the grinding rollers 1, 2 is provided with a wear-protection profile 3 which has a multiplicity of welds 4 of an iron-chromium-carbon hard alloy having a hardness of greater than 55 HRC (Rockwell hardness). As shown in particular in FIGS. 3 and 4, the welds in this exemplary embodiment take the form of short welded seams with a geometric ratio of length L to width B of approximately 3. The height H is at most 15 mm and is preferably in the range from approximately 7 to 10 mm. In the exemplary embodiment shown in FIG. 2, the welds 4 are applied in a repeating pattern which in this case forms a herringbone pattern. However, within the scope of the invention, other patterns and in principle irregular patterns are also conceivable. FIG. 5 shows various patterns for the wear-protection profile.

The welds 4 can in principle adopt any shape as long as the geometric length-to-width ratio of ≦4 is retained. FIGS. 6 and 7 show a preferred embodiment in which the welds take the form of spot welds 41. The diameter D is preferably in the range from 7 to 25 mm, preferably in the range from 10 to 20 mm and the height is preferably in the range from 7 to 20 mm.

In addition to the weld forms shown in FIGS. 3 and 6, other forms are however also conceivable, some examples of which are shown in FIG. 8.

The wear-protection profile 3 is applied to a part, in particular a main part 5, which can in particular be formed from the following materials:
a. a bainitic nodular cast iron having an elongation at break of approximately 0.1 to 2.5%, a compressive strength of 1000 to approximately 1800 MPa and a hardness of 42 to 55 HRC or
b. a carbidic cementite-solidified cast iron material having carbides of iron, chromium, molybdenum, vanadium and/or niobium or
c. a forged material.

In that context, it is conceivable that the main part 5 is first provided over its entire surface area with the welds 4 in one or more layers, and that only the outermost layer takes the form of a pattern as is indicated by way of example in FIG. 5. If the main part 5 is made of a cast material, it is not absolutely necessary to apply welding layers over its entire surface area, such that the wear-protection pattern can be welded on directly.

The wear profile serves on one hand to protect the relatively soft main part 5 and on the other hand also to facilitate drawing-in of the material to be comminuted. By virtue of a suitable choice for the value of the separation A_{S} (see FIG. 3) between adjacent welds 4, material to be comminuted can stick between the welds and thus form an autogenous wear protection. Since the welds 4 naturally tend to have rounded contours, generally part of the welds will stand proud of the autogenous wear-protection layer and ensure drawing-in of the material.

The trials upon which the invention is based have shown that welds made of an iron-chromium-carbon hard alloy having a hardness of greater than 55 HRC can be formed without cracks if the geometric ratio of length L to width B is chosen to be ≦4, preferably ≦2.5, more preferably ≦1.5. The crack-free formation also results in a longer service life of the wear-protection profile.

1-10. (canceled)

11. An apparatus for comminuting abrasive materials, comprising:
at least one component; and
a welded wear protection profile disposed on an outer surface of said at least one component and formed from a plurality of welds of an iron-chromium-carbon hard alloy having a hardness of greater than 55 HRC, said plurality of welds having a geometric length-to-width ratio of ≦4.

12. The apparatus of claim 1, wherein said welds are crack-free.

13. The apparatus of claim 1, wherein said welds are separated a predefined distance from each other.

14. The apparatus of claim 1, wherein said welds protrude from said outer surface of said at least one component and have a height of up to 15 mm.

15. The apparatus of claim 1, wherein said welds are disposed on said at least one component in a repeating geometric pattern.

16. The apparatus of claim 1, wherein a filler material used for the welds has formed carbides of iron and of chromium, and also special carbides.

17. The apparatus of claim 1, wherein said wear protection profile is disposed on a body made of at least one of:
a. a bainitic nodular cast iron having an elongation at break of approximately 0.1 to 2.5%, a compressive strength of 1000 to approximately 1800 MPa and a hardness of 42 to 55 HRC,
b. a carbidic cementite-solidified cast iron material having carbides of at least one of iron, chromium, molybdenum, vanadium or niobium, or
c. a forged material.

18. The apparatus of claim 1, wherein said welds are one of weld seams or spot welds.

19. The apparatus of claim 1, wherein said welds are spot welds having a diameter of between 7 mm and 25 mm, and a height of between 7 mm and 20 mm.

20. The apparatus of claim 1, wherein said component is one of a cylinder, a roller, a cone, a ball, a crushing jaw, a grinding track, or plate segments of a mill.
